(19) United States
(12) Patent Application Publication
(10) Pub. No.: US 2024/0120752 A1
(43) Pub. Date: Apr. 11, 2024

(54) ADAPTIVE CURRENT CONTROL PASSIVE BALANCING

(71) Applicant: STEWART & STEVENSON LLC, Houston, TX (US)

(72) Inventor: David HANSON, Houston, TX (US)

(21) Appl. No.: 18/371,556

(22) Filed: Sep. 22, 2023

Related U.S. Application Data
(60) Provisional application No. 63/415,161, filed on Oct. 11, 2022.

(51) Int. Cl. H02J 7/00

(52) U.S. Cl. CPC H02J 7/0016; H02J 7/0047

(57) ABSTRACT

A battery pack includes a first parallel cell group, a second parallel cell group, a first passive balancing circuit, a second passive balancing circuit, and a balancing controller operatively coupled to the first and second passive balancing circuits positioned to control the first and second switches. The balancing controller may measure a voltage of the first parallel cell group and second parallel cell group, provide a pulse-width modulated signal to the first switch with the balancing controller to control the first switch, and dissipate stored energy from the first parallel cell group through the first load resistor.

### CROSS-REFERENCE TO RELATED APPLICATIONS

This application is a nonprovisional application which claims priority from U.S. provisional application No. 63/415,161, filed Oct. 11, 2022, which is incorporated by reference herein in its entirety.

### TECHNICAL FIELD/FIELD OF DISCLOSURE

The present disclosure relates to battery balancing systems, and specifically to passive battery balancing systems.

### BACKGROUND OF THE DISCLOSURE

Battery packs are typically formed from a plurality of battery cells arranged in parallel and in series to give a desired voltage output and capacity. Individual battery cells within the battery pack may have different capacities and different operating characteristics and may thus be at a different state of charge than other individual battery cells. Cells connected in parallel tend to naturally balance, but batteries connected in series cannot match state of charge without additional balancing circuitry. Passive balancing selectively connects the cells in series to a resistive load to dissipate energy from the most-charged cells such that all cells achieve full state of charge or reach minimal state of charge at roughly the same time, thus preventing overcharge or undercharge scenarios, increasing safety and longevity of the battery pack. However, because passive balancing necessarily involves the generation of heat, if any component of the system reaches too high of a temperature, the balancing operation and potentially the charging or discharging of the battery pack must be discontinued to avoid damage from heat to the system.

### SUMMARY

The present disclosure provides for a method. The method may include providing a battery pack. The battery pack may include a first parallel cell group, the first parallel cell group including one or more individual battery cells. The battery pack may include a second parallel cell group, the second parallel cell group including one or more individual battery cells. The battery pack may include a first passive balancing circuit, the first passive balancing circuit operatively coupled to the first parallel cell group, the first passive balancing circuit including a first load resistor and a first switch coupled such that when the first switch is closed, the first load resistor is operatively coupled to the first parallel cell group. The battery pack may include a second passive balancing circuit, the second passive balancing circuit operatively coupled to the second parallel cell group, the second passive balancing circuit including a second load resistor and a second switch coupled such that when the second switch is closed, the second load resistor is operatively coupled to the second parallel cell group. The battery pack may include a balancing controller operatively coupled to the first and second passive balancing circuits positioned to control the first and second switches. The method may include measuring a voltage of the first parallel cell group and second parallel cell group with the balancing controller, providing a pulse-width modulated signal to the first switch with the balancing controller to control the first switch, and dissipating stored energy from the first parallel cell group through the first load resistor.

In addition, the present disclosure calls for a method. The method includes providing a battery pack, the battery pack including a cell group, the cell group including one or more individual battery cells having a first output voltage. The method also includes providing a balancing circuit, the balancing circuit being a booster converter, the balancing circuit including an inductor, the inductor connected to a switch, a diode, a capacitor, and a load resistor. The switch has an open and closed position. The method further includes opening the switch, closing the switch, and increasing the first voltage to a second voltage, wherein the second voltage is higher than the first voltage.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a depiction of a battery pack consistent with at least one embodiment of the present disclosure.

FIG. 2 is a schematic view of a passive balancing circuit for a cell of a battery pack consistent with at least one embodiment of the present disclosure.

FIG. 2a is a schematic view of a balancing circuit for a cell of a battery pack consistent with at least one alternative embodiment of the present disclosure.

FIG. 3 is a graph depicting discharge current and cell voltage over time of a cell using a passive balancing circuit consistent with at least one embodiment of the present disclosure.

FIG. 4 is a graph depicting discharge current and cell voltage of a cell using a passive balancing circuit consistent with at least one embodiment of the present disclosure.

FIG. 5 is a graph depicting discharge current and temperature of a cell using a passive balancing circuit consistent with at least one embodiment of the present disclosure.

FIG. 6 is a graph depicting discharge current and cell voltage of a cell using a passive balancing circuit consistent with at least one embodiment of the present disclosure.

FIG. 7 is a graph depicting discharge current and cell voltage of a cell using a passive balancing circuit consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

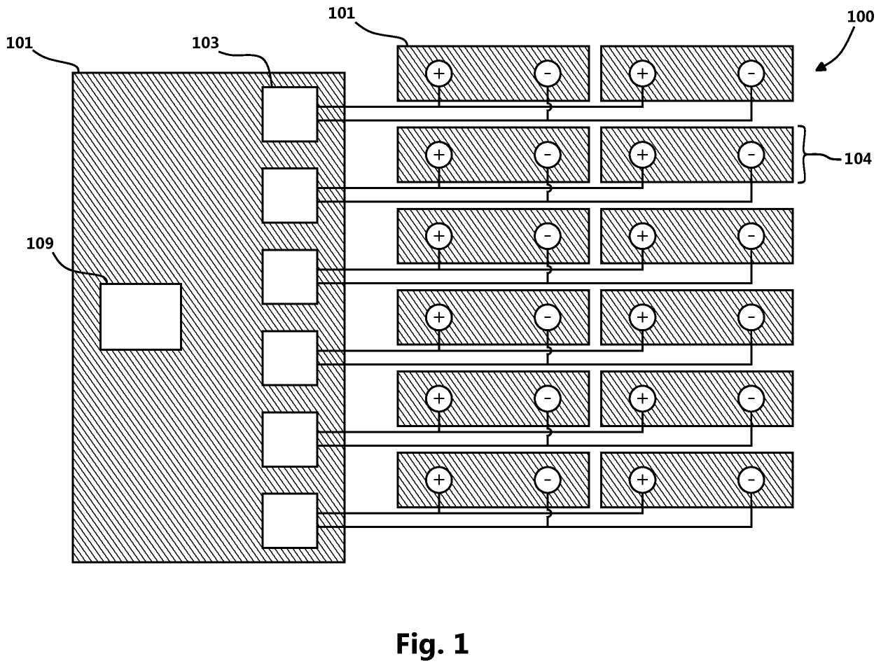

FIG. 1 depicts battery bank 100. Battery bank 100 includes multiple cells 101. Cells 101 may be arranged in parallel and in series such as, for example and without limitation, the 2-parallel by 6-series arrangement shown in FIG. 1. For the purpose of this disclosure, and as would be understood in the art, a parallel cell group 104 may include one or more individual battery cells 101 arranged in parallel. Multiple parallel cell groups 104 may be built up in series to form battery bank 100. Battery bank 100 further includes passive balancing circuits 103, which may be controlled by balancing controller 109. Passive balancing circuits 103 are arranged for each of parallel cell groups 104 to, for example and without limitation, provide passive balancing among parallel cell groups 104.

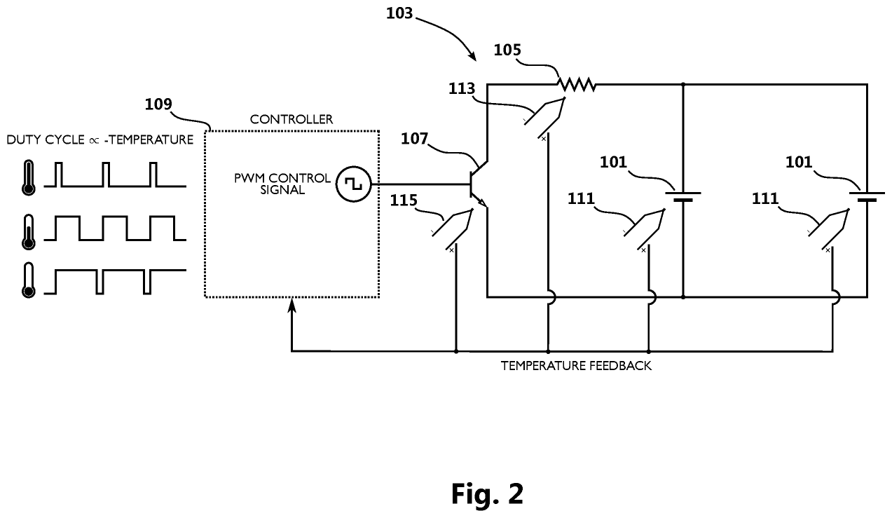

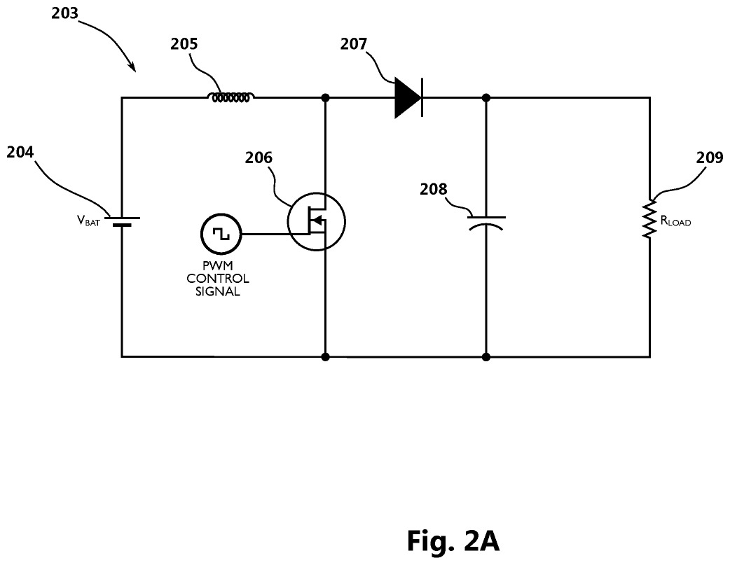

FIG. 2 depicts an example of a passive balancing circuit 103 connected to parallel cell group 104, which, in the shown example embodiment, includes two cells 101. As shown, each individual battery cell 101 of parallel cell group 104 is connected in parallel such that they share a positive and negative terminal. These terminal outputs are coupled, in series, to additional parallel cell groups 104 as shown in FIG. 1, though this connection is omitted for clarity in FIG. 2.

In some embodiments, passive balancing circuit 103 may include load resistor 105. Load resistor 105 may be operatively coupled to the positive and negative terminals of each cell 101 through switch 107 such that cells 101 of parallel cell group 104 may be selectively electrically connected to or disconnected from load resistor 105. As understood in the art and without being bound by principle, load resistor 105 may, when connected to parallel cell group 104, dissipate stored energy from cells 101 of parallel cell group 104 as heat energy due to the flow of current through load resistor 105, referred to herein as a discharge current, according to Watt's Law. Watt's Law may be stated as P=I²R, where P is the power dissipated, I is the current passing through load resistor 105, and R is the resistance value of load resistor 105. Such dissipation of stored energy may be used in a passive balancing operation to remove stored energy from cells 101 of parallel cell group 104 where parallel cell group 104 is the most-charged parallel cell group 104 in battery bank 100.

Switch 107 may be controlled by balancing controller 109. In some embodiments, balancing controller 109 may be connected to each switch 107 of each passive balancing circuit 103 of battery bank 100 and thus control all passive balancing circuits 103 in battery bank 100. In other embodiments, a balancing controller 109 may be included to control switch 107 of each passive balancing circuit 103. In such an embodiment, an external controller may control each such balancing controller 109 and thus coordinate the passive balancing of each parallel cell group 104 to passively balance parallel cell group 104 of battery bank 100.

Balancing controller 109 may coordinate passive balancing of battery bank 100 by, for example and without limitation, measuring the voltage of each parallel cell group 104 such as during a charging or discharging operation to determine the state of charge of each parallel cell group 104. One of ordinary skill in the art will understand that the parallel individual battery cells 101 that may make up each parallel cell group 104 may automatically balance as they are connected in parallel. As understood in the art, balancing controller 109 may operate switches 107 of each passive balancing circuit 103 as needed such that cells with higher state of charge are connected to the corresponding load resistors 105 to dissipate stored energy as discussed further below. Passive balancing, as described herein, may be used such that during a charging operation, all parallel cell groups 104 reach full voltage, also referred to as 100% state of charge (SOC), at approximately the same time, known in the art as a “top balanced” system. Passive balancing, as described herein, may also be used such that during a discharge operation, all parallel cell groups 104 reach minimum voltage or minimum SOC at approximately the same time, known in the art as a “bottom balanced” system.

During a balancing operation, the temperature of each cell 101, each load resistor 105, and each switch 107 may be monitored by temperature sensors coupled to the corresponding component, depicted in FIG. 2 as cell temperature sensor 111, resistor temperature sensor 113, and switch temperature sensor 115, respectively. In some embodiments, an ambient temperature sensor may be used to measure the temperature of the ambient air surrounding components of battery bank 100. Each of cell temperature sensor 111, resistor temperature sensor 113, and switch temperature sensor 115 may be operatively coupled to balancing controller 109 which may receive, store, and process the temperatures measured thereby. Based on these measured temperatures and states of charge of cells 101, balancing controller 109 may operate switches 107 using a pulse-width modulation (PWM) signal to control the discharge current passing through the load resistor 105 of each passive balancing circuit 103. In some embodiments, each individual battery cell 101 of parallel cell group 104 may include a separate cell temperature sensor 111 such that the temperature of each individual battery cell 101 of parallel cell group 104 may be monitored.

Because the power dissipated by heat through load resistor 105 is proportional to the square of the discharge current as discussed above, the temperature of each load resistor 105 and switch 107 may be managed by controlling the discharge current. By increasing the duty cycle, defined as the ratio of time spent on versus time spent off, of switch 107, the discharge current may be increased up to the theoretical maximum current for the given state of charge, i.e. the voltage of parallel cell group 104, as defined according to Ohm's Law, which states, V=IR, where V is the voltage of parallel cell group 104.

FIG. 2a depicts an alternative embodiment of a balancing circuit. In FIG. 2a, balancing circuit 203 is a boost converter. The boost converter adjusts voltage output and allows adjustment of power dissipation.

Balancing circuit 203 includes cell group 204. Cell group 204 is connected to inductor 205 and switch 206. Switch 206 may be, for example and without limitation, a power MOSFET. Switch 206 may be turned off and on by using Pulse Width Modulation (PWM), which may be frequency based. Using a frequency-based switch 206 allows an operator to “tune” balancing circuit 203 to adjust the voltage leaving balancing circuit 203.

Balancing circuit 203 further includes diode 207. Diode 207 acts as a second switch that prevents current from flowing back into the battery when switch 206 is closed. Balancing circuit 203 further includes capacitor 208 and load resistor 209.

Balancing circuit 203 has two modes of operation, i.e, when switch 206 is in the closed position and diode 207 is in the open position (“closed”) and when switch 206 is in the open position and diode 207 is in the closed position (“open”). When balancing circuit 203 is in the closed position, switch 206 allows the flow of current through it. All the current will flow through the closed path including inductor 205, switch 206 and back to cell group 204. Inductor 205 in balancing circuit 203 stores energy in the form of the magnetic field.

When balancing circuit 203 is in the open position, inductor 205 releases the energy from the closed position. The released energy is ultimately dissipated in load resistor 209, which helps to maintain the flow of current in the same direction through the load and also steps up the output voltage.

When balancing circuit 203 is switched back to the open position, current stored in capacitor 208 flows through load resistor 209 to balance current flow with boosted voltage. By opening and closing switch 206, voltage from voltage cell group 204 may be boosted to a higher voltage.

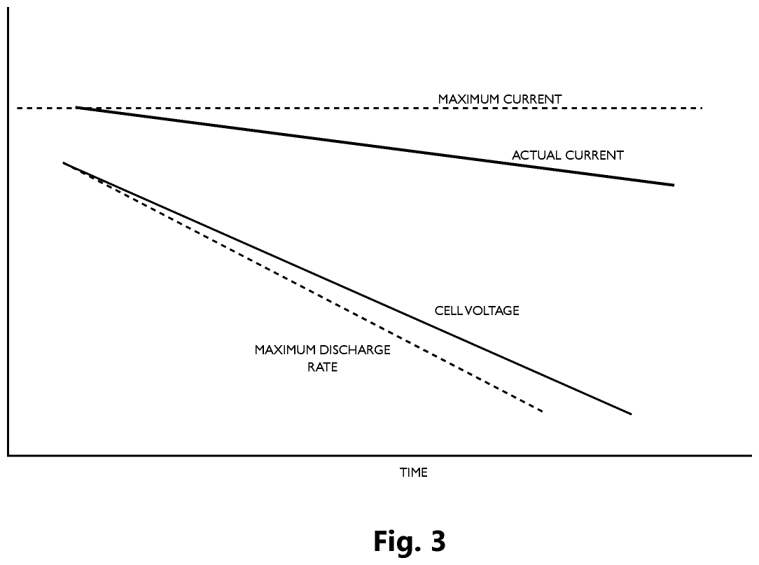

The 100% duty cycle current over time as the voltage of parallel cell group 104 is decreased is shown in FIG. 3. Without the ability to limit the current, the resistance value of load resistor 105 may be set so that the maximum current is not exceeded at the maximum voltage of parallel cell group 104 to prevent damage to components of battery bank 100. Since the resistance value of load resistor 105 is fixed, as the voltage of parallel cell group 104 decreases, the load current also decreases, according to Ohm's Law.

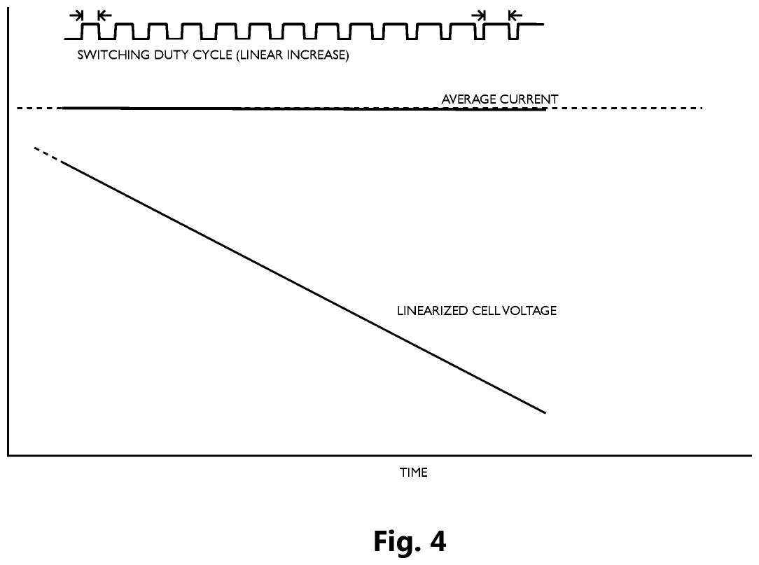

FIG. 4 depicts how modulation of discharge current with the switching duty cycle of switch 107 allows the effective resistance value of load resistor 105 to be reduced. The discharge current may thereby be held at a maximum accepted value even though the voltage of parallel cell group 104 is less than its maximum.

However, in certain circumstances, the amount of heat generated in parallel cell group 104, load resistor 105, and switch 107 caused by discharging at the theoretical maximum discharge current may result in a component temperature above a desired level, which may risk damaging the respective component itself or other components of the system to which each component is coupled. By managing the duty cycle of switch 107 through the PWM signal sent to switch 107 and thus controlling the discharge current passing through load resistor 105, balancing controller 109 may manage the temperature of each component, thus preventing or reducing the likelihood of an over-temperature event.

For example, with reference to FIG. 4, by varying the duty cycle linearly, balancing controller 109 may provide a generally constant discharge current and thus a generally constant power dissipation for load resistor 105. Once at steady state, such a discharge current would result in a generally constant heat output for load resistor 105 and switch 107.

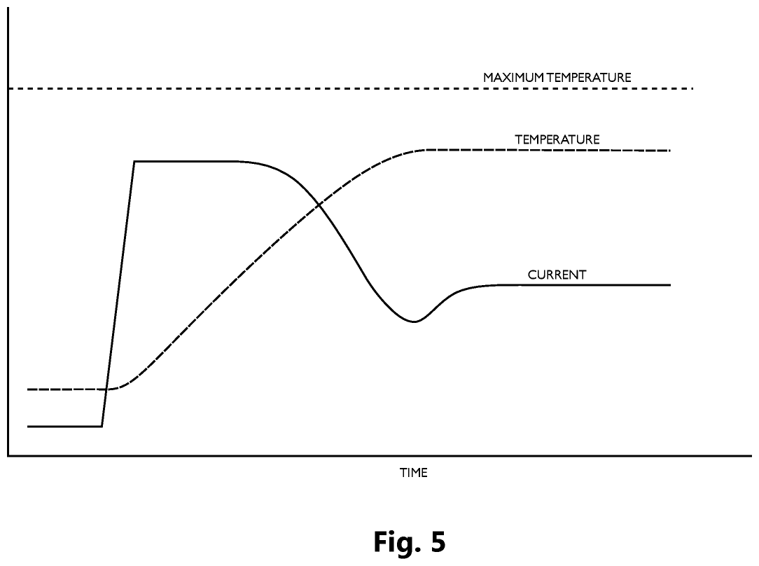

As another example, with reference to FIG. 5, in a situation in which the temperature of one or more of cells 101, load resistor 105, or switch 107, as measured by cell temperature sensor 111, resistor temperature sensor 113, and switch temperature sensor 115, respectively, increases above a threshold temperature or is otherwise trending to a higher temperature according to, for example and without limitation, a PID (proportional, integral, derivative) controller operated by balancing controller 109, the duty cycle of switch 107 may be reduced, thus reducing the discharge current and the power dissipated by load resistor 105. This reduction of discharge current may, for example and without limitation, allow continued passive balancing without overheating cells 101, load resistor 105, or switch 107.

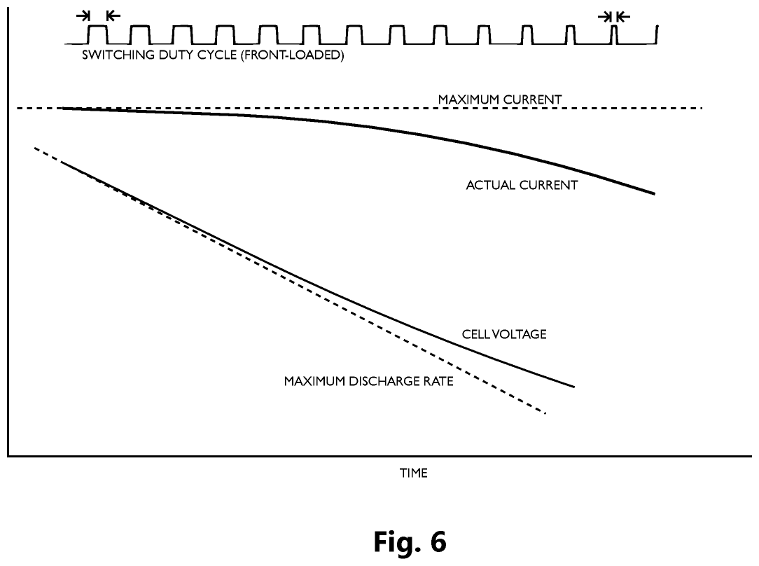

As an example, with reference to FIG. 6, in a situation in which the chemistry of cells 101 benefit from a gradually decreasing discharge current, balancing controller 109 may provide a gradually decreasing duty cycle to achieve the desired current profile. In this way, balancing controller 109 can capitalize on any beneficial effect of variable discharge current including, but not limited to, temperature control.

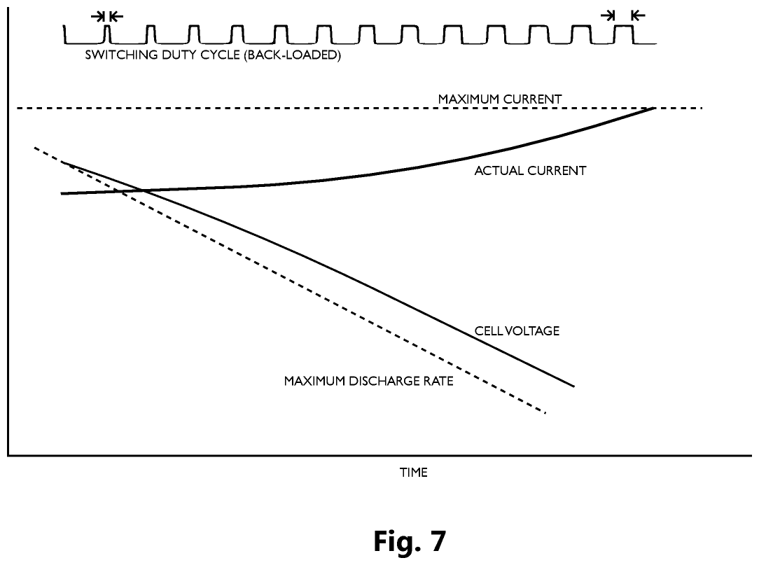

As a further example, with reference to FIG. 7, in a situation in which the chemistry of cells 101 benefit from a gradually increasing discharge current, balancing controller 109 may provide a gradually increasing duty cycle to accommodate this battery design.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method comprising:
providing a battery pack, the battery pack including:
a first parallel cell group, the first parallel cell group including one or more individual battery cells;
a second parallel cell group, the second parallel cell group including one or more individual battery cells;
a first passive balancing circuit, the first passive balancing circuit operatively coupled to the first parallel cell group, the first passive balancing circuit including a first load resistor and a first switch coupled such that when the first switch is closed, the first load resistor is operatively coupled to the first parallel cell group;
a second passive balancing circuit, the second passive balancing circuit operatively coupled to the second parallel cell group, the second passive balancing circuit including a second load resistor and a second switch coupled such that when the second switch is closed, the second load resistor is operatively coupled to the second parallel cell group;
a balancing controller operatively coupled to the first and second passive balancing circuits positioned to control the first and second switches;
measuring a voltage of the first parallel cell group and second parallel cell group with the balancing controller;
providing a pulse-width modulated signal to the first switch with the balancing controller to control the first switch; and
dissipating stored energy from the first parallel cell group through the first load resistor.

2. The method of claim 1, wherein providing a pulse-width modulated signal comprises modulating the energy dissipation such that the discharge current remains generally constant regardless of the voltage of the first parallel cell group.

3. The method of claim 1, wherein providing a pulse-width modulated signal comprises modulating the energy dissipation such that the discharge current gradually increases.

4. The method of claim 1, wherein providing a pulse-width modulated signal comprises modulating the energy dissipation such that the discharge current gradually decreases.

5. The method of claim 1, further comprising:
measuring a temperature of an individual battery cell of the first parallel cell group; and
modulating the discharge current with the balancing controller to prevent the temperature of the individual battery cell from increasing above a predetermined temperature.

6. The method of claim 1, further comprising:
measuring a temperature of the first switch; and
modulating the discharge current with the balancing controller to prevent the temperature of the first switch from increasing above a predetermined temperature.

7. The method of claim 1, further comprising:
measuring a temperature of the first load resistor; and
modulating the discharge current with the balancing controller to prevent the temperature of the first load resistor from increasing above a predetermined temperature.

8. A method comprising:
providing a battery pack, the battery pack including:
a cell group, the cell group including one or more individual battery cells having a first output voltage;
providing a balancing circuit connected to the cell group, the balancing circuit being a booster converter, the balancing circuit including an inductor, the inductor connected to a switch, a diode, a capacitor, and a load resistor;
wherein the switch has an open and closed position;
opening the switch;
closing the switch;
increasing the second voltage to a second voltage, wherein the second voltage equals the first voltage.

9. The method of claim 8, wherein the switch is a power MOSFET.

10. The method of claim 9, further comprising opening the switch and closing the switch using Pulse Width Modulation (PWM).

11. The method of claim 10, wherein the PWM is frequency based.

12. The method of claim 11, wherein the third voltage is determined by frequency tuning the PWM.
